(19) United States
(12) Patent Application Publication
(10) Pub. No.: US 2012/0272301 A1
(43) Pub. Date: Oct. 25, 2012

(54) CONTROLLED USER ACCOUNT ACCESS WITH AUTOMATICALLY REVOCABLE TEMPORARY PASSWORD

(75) Inventors: Dorathea LoBean, Raleigh, NC (US); Adrian X. Rodriguez, Durham, NC (US); Ian C. Tewksbury, Morrisville, NC (US)

(73) Assignee: INTERNATIONAL BUSINESS MACHINES CORPORATION, Armonk, NY (US)

(21) Appl. No.: 13/091,249

(22) Filed: Apr. 21, 2011

(51) Int. Cl. H04L 9/32; G06F 21/00

(52) U.S. Cl. 726/6

(57) ABSTRACT

Systems and computer-implemented methods are disclosed for providing controller access to a normally single-user account. In an example system, a primary user is provided with a primary password to the user account. A secondary user may be temporarily authorized by generating a temporary password selected independently of the primary password. The user account may be accessed by entering either the primary password or the temporary password. The temporary password is automatically revoked in response to granting access with the primary password. The secondary user is thereby provided with temporary access to the user account that is revocable by the primary user at any time without having to share the primary password with the secondary user and without having to change the primary password.

### BACKGROUND

1. Field of the Invention

The present invention relates to electronic user accounts, and more particularly to systems and methods for controlling access to electronic user accounts.

2. Background of the Related Art

Passwords are commonly used to control access to electronic content. For example, electronic content may be stored on a computer system in one or more password-protected files. Efforts are made to restrict knowledge of the password to authorized users of the electronic content. In a familiar example, the electronic content is an account holder's account information stored on a server of a merchant or creditor. The account holder may access the account information over the Internet by first supplying the correct password. Other familiar examples include the use of passwords to restrict log-in access to computers and portable electronic devices, and/or to restrict access to selected files or functionalities on the computers and portable electronic devices.

Some entry-level or mid-size cloud services and websites offer only a single user name and master password combination per account. However, access to that account may occasionally need to be shared among multiple entities, such as managers, testers, developers, and sales teams. Instead of sharing the single user name and password combination with all of these different entities, the person responsible for the account may change the master password to a new password to share with others, and subsequently change the password back to the master password. As a result, control over the account is temporarily lost, and the security of the account may be compromised. For example, the new password may be decipherable if the person selects the new password as a function of known personal information (e.g. the user's birthdate). Also, the person selecting the new password may unintentionally select a variation of the master password, making the master password more predictable. Keeping track of the changing value of the password also takes time and effort.

### BRIEF SUMMARY

A method is disclosed for controlling access to a user account. A single username is associated with a user account. A temporary password is selected that is distinct from the primary password. Access to the user account is granted in response to receiving either the primary password or the temporary password. The temporary password is automatically revoked in response to receiving the primary password. The method may be implemented by a computer executing computer usable program code for performing these steps.

A system is also disclosed. An electronic user account has a single username and a primary password. An electronic password generator is provided for selectively generating a temporary password for the electronic user account, in addition to the primary password. A user interface is provided for receiving login credentials provided by a human user, for identifying whether the login credentials include the primary password or temporary password, for automatically granting access to the user account in response to entry of the primary password or temporary password, and for automatically revoking the temporary password in response to entry of the primary password.

### BRIEF DESCRIPTION OF THE SEVERAL VIEWS OF THE DRAWINGS

FIG. 1 is a schematic diagram of an example of a system providing controlled access to a user account.

FIG. 2 is a flowchart outlining an example of a method for providing controlled access to a user account.

### DETAILED DESCRIPTION

A system and method are disclosed that provide a novel way to temporarily grant secondary access to a single-user account normally restricted to a single, account-specific username and password. According to this system and method, a single user interface may authorize and track multiple users. The user account may be any of a variety of account types, although the method is particularly suited to entry-level or mid-size cloud services and websites that would conventionally provide a single username and password combination per account. Access to the account is normally restricted to login credentials that include an account username and a primary password. To temporarily authorize a secondary user, a temporary password is generated and assigned to the secondary user. In one implementation, program code used to authorize access to the user account may include a temporary password field that defaults to the value of the primary password, so that access is normally restricted to a user having knowledge of the primary password. A distinct value for the temporary password field may then be selectively generated to provide temporary access by the secondary user. The particular password (i.e. primary or temporary) used to access the account may be logged, to track which users have accessed or are currently accessing the account. The primary user may revoke the temporary password at any time simply by logging in to the user account using the primary password, which automatically revokes the temporary password. Thus, the primary user may grant and subsequently revoke access to a secondary user without having to share or change the primary password.

To increase account security, the temporary password may be selected by the secondary user, who has no knowledge of the primary password. As a result, the temporary password bears no intentional relationship to the primary password, so that the temporary password is not decipherable based on the value of the primary password. The temporary password remains valid until the primary user next logs into the user account with the primary password, in response to which the temporary password is revoked. The temporary password may be revoked, for example, by automatically restoring the temporary password field within the program code to its default value.

As an example application, a website or service with a single user account will be able to securely grant temporary access to a third-party development or test team. This cannot be done conventionally where a user account is limited to having only one username associated with the user account without disclosing the value of the primary password to the third-party development or test team. With the system and method disclosed herein, the primary password remains valid, and the third-party may be given a distinct temporary password that remains valid until the primary password is next used to log in. In this implementation, none of the original holders of the primary password will need to be notified because the primary password may continue to be valid and unchanged.

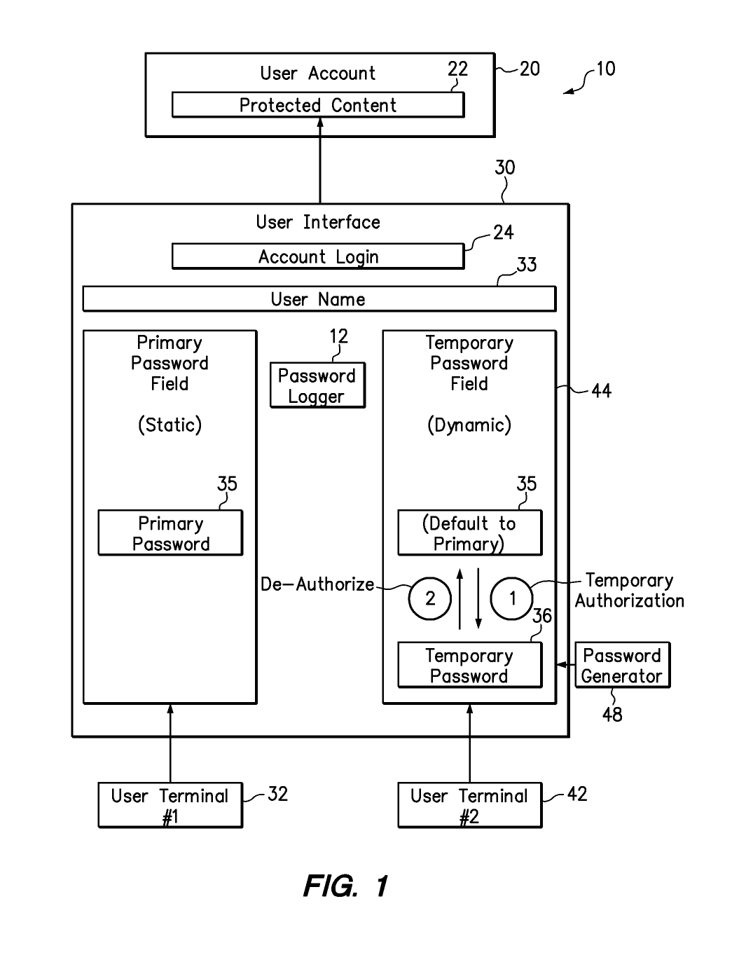

FIG. 1 is a schematic diagram of one example of a system 10 providing controlled access to a user account 20. The user account 20 may normally be a single-user account, such as an account assigned to the owner or operator of a website. Protected content 22 is electronic content associated with the user account 20. Access to the protected content 22 is limited to a user who supplies valid login credentials. In the case of a user account associated with a website, for example, the protected content 22 may include both publicly-viewable content and private content. Access to publicly-viewable content may be restricted, for example, by requiring valid login credentials to modify the publicly viewable content. Access to private content may be restricted, for example, by requiring valid login credentials to modify or even view the private content.

A user interface 30 is provided to facilitate access to the user account 20. The user interface 30 may be accessed by a user via a user terminal. By way of example, the system 10 of FIG. 1 includes a primary user terminal 32 for access by a primary user and a secondary user terminal 42 for access by a secondary user. The user terminals 32, 42 include hardware, such as input/output peripherals, which a user may use to provide input to the user interface 30, initially by supplying login credentials to access the user account 20, and to thereafter view and modify the protected content 22 associated with the user account 20. The user interface 30 includes software elements configured to process the input from the user and to selectively provide access to the user account 20. The user terminals 32, 42 may be located anywhere that a network connection is available. The primary user terminal 32 and the secondary user terminal 42 are shown as being separate user terminals, since the primary and secondary users may desire to access the user account 20 from different geographical locations. Alternatively, however, a primary user and a secondary user may separately access the user account 20 using the same user terminal.

Login credentials entered at the respective primary and secondary user terminals 32, 42 are communicated to an account login module 24. The account login module 24 includes software code to determine the validity of the entered login credentials and to provide access to the user account 20 in response to determining that the login credentials are valid. Valid login credentials include a username 33 in combination with a primary password 35 or the same username 33 in combination with a temporary password 36 (if a temporary password 36 is currently selected/enabled). The username 33 is the only username associated with the user account 20, and has a static value. The primary password 35 is the main password associated with the user account 20. A primary password field 34 that contains the primary password 35 is also static; although it may be possible to change the value of the primary password 35, such as in the event of an inadvertent disclosure of the primary password 35 to an unauthorized party, the primary password 35 will generally remain unchanged. By contrast, a temporary password field 44 included with the user interface 30 is dynamic. The temporary password field 44 defaults to the value of the primary password 35, but may be changed if the temporary password 36 has been selected having a value distinct from the primary password 35.

The only valid login credentials other than the username in combination with the primary password are the same username 33 in combination with the temporary password 36. The result of setting the default value of the temporary password field 44 equal to the primary password 35 is to require entry of the primary password 35 for accessing the user account 20, which prevents access to the user account 20 by anyone other than the primary user. When a secondary user is to be authorized, the temporary password field 44 is temporarily changed from the default value of the primary password 35 to the temporary password 36. A password generator 48 is optionally provided to generate the temporary password 36 independently of the value of the primary password 35. The password generator 48, itself, may generate the temporary password 36. Alternatively, the secondary user may select the temporary password 36. For example, the password generator 48 may receive a candidate value for the temporary password entered by a secondary user, and apply password criteria (e.g. minimum password length or required use of alternate characters) to determine that the selected password value conforms to the password criteria. To de-authorize the secondary user, the primary user need only login to the user account 20 using the primary password 35, which automatically revokes the temporary password 36 and restores the temporary password field 44 to the value of the primary password 35.

To maintain security of the user account 20, the temporary value 46 is selected independently of the primary password 35. For example, the temporary value 46 may be selected by the secondary user or selected by a random password generator and communicated to the secondary user. Selecting the temporary value 46 of the temporary password 44 independently of the primary password 35 desirably prevents the temporary password from bearing any intentional relationship to the primary password 35 that might consciously or subconsciously result, for example, from having the primary user select the temporary password 46.

A password logger 12 can be included to keep track of whether the primary password 35 or the temporary password 36 was used to access the user account 20. The password logger 12 may identify and track users based solely on the password used, since only one username 33 exists for the user account 20. The primary password 35 may be used to access the user account 20 at any time. The temporary password 36, when selected, may also be used to access the user account 20 at any time for so long as the temporary password 36 remains valid. When the password logger 12 notes the primary password 35 being used to access the user account 20, the user interface 30 may automatically revoke the temporary password 36 by setting the value of the temporary password field 44 back to the value of the primary password 35. Optionally, more than one different temporary password 36 may be generated and active at any given time. For example, different secondary users may be given different temporary passwords 36, each distinct from the static primary password 35. The password logger 12 can track which of the multiple secondary users have accessed the user account 20 based on the respective temporary passwords 36. When the primary password 35 is entered, all active temporary passwords 36 are automatically revoked.

Software elements of the system 10 may reside on one or more servers in a cloud-computing environment. Thus, the physical location of each of these software components may be distributed among one or more servers in one or more geographical locations, in communication over a network. As an example, the primary and secondary terminals 32, 42 may be networked with a first remote server having software included with the user interface 30 used to prompt for and receive login credentials. The account login module 24 may reside on the same or another remote server networked with the first remote server, and the protected content 22 may reside on yet another server or group of servers in a datacenter that supports a website.

As described above, in the system 10 of FIG. 1, the user account 20 may be accessed on-demand by supplying either the primary password 35 or the temporary password 36 (if currently enabled). Because the value of the temporary password field 44 defaults to the primary password 35, accessing the user account 20 normally requires a user to have knowledge of the primary password 35. The primary password 35 is kept secret, so that only the primary user is able to access the user account 20. The process of authorizing and de-authorizing the secondary user never requires sharing the primary password 35 with the secondary user and never requires changing the primary password 35. Accordingly, the primary user does not have to keep track of more than one password, and does not even need to keep track of which secondary user(s) are currently authorized. The primary user may easily de-authorize any existing secondary user(s) simply by logging in to the user account 20 using the primary password 35.

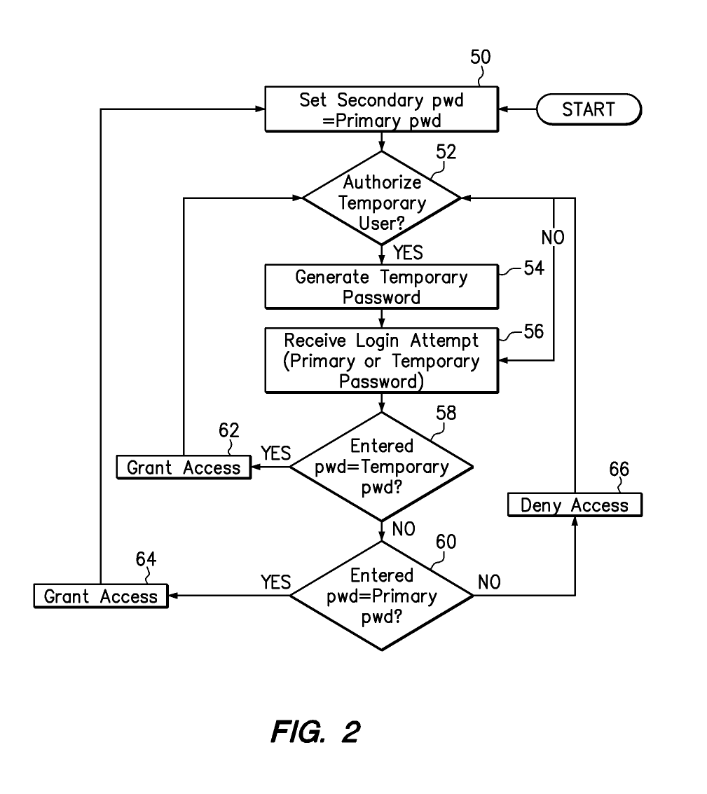

FIG. 2 is a flowchart outlining an example method for providing controlled access to a user account having only one username and one primary password normally associated with the username. The method may be applied, for instance, to the user account 20 of FIG. 1. In step 50, a temporary password field is set equal to the primary password, by default. The primary password authorizes access to the user account in combination with a particular primary username. Conditional step 52 is to determine whether to authorize a secondary user to access the user account. A secondary user may be authorized at any time, and it is not necessary for a secondary user to be authorized in the exact sequence shown in the flowchart. If a secondary user is to be authorized per conditional step 52, then a temporary password is generated in step 54. In step 56, a login attempt is received. The login attempt involves receiving at least a password, which may be either the primary or any presently enabled temporary password, either alone or in combination with the single username associated with the user account. If no secondary user is to be authorized in the current iteration of conditional step 52, then the method skips directly to step 56.

The password received in step 56 may be a valid primary password, a valid temporary password. Any other password attempt may be treated as an invalid password. Conditional steps 58 and 60 are used to determine whether the entered password is a valid password. If a valid temporary password is entered per conditional step 58, then access to the user account is granted per step 62. If a valid primary password value is instead entered per conditional step 60, then access to the user account is granted per step 64. If access is granted per step 62 (in response to entry of a valid temporary password per conditional step 58) then the method returns to step 52, to determine whether login credentials for another secondary user are to be added. If access is instead granted per step 64 (in response to entry of a valid primary password in conditional step 60) then the method instead returns to step 50, which automatically revokes any temporary passwords by restoring the temporary password field to its default value equal to the primary password. If neither a valid temporary password nor a valid primary password was entered in steps 58 or 60, respectively, then access to the user account is denied in step 66. The method may then return to step 52, which determines whether to add a new secondary user.

The method supports multiple secondary users, each being temporarily assigned a unique temporary password. In successive iterations of conditional step 52, a secondary user may already be authorized, and an additional temporary password may be generated to authorize an additional secondary user. Any number of temporary passwords may thus be active at any given instant. However, all active temporary passwords will be unilaterally revoked in response to receiving the correct primary user login credentials, effectively de-authorizing any secondary users. This allows any number of secondary users to be authorized at any given time, each having a unique temporary password that is distinct from the primary password.

Desirably, according to the method outlined in the flowchart of FIG. 2, the primary password does not need to be changed in order to authorize the one or more temporary passwords. The one or more temporary passwords may be revoked at any time simply by entering the primary login credentials.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
associating a single username with a user account;
selectively setting a temporary password distinct from the primary password;
granting access to the user account in response to receiving either the primary password or the temporary password; and
automatically revoking the temporary password in response to receiving the primary password.

2. The method of claim 1, further comprising:
granting access to the user account only in response to receiving either the primary password in combination with the username or the temporary password in combination with the username.

3. The method of claim 1, wherein automatically revoking the temporary password comprises changing the temporary password to a different value.

4. The method of claim 1, wherein automatically revoking the temporary password comprises changing the value of a temporary password field to a default value equal to the primary password.

5. The method of claim 1, further comprising:
a primary user selecting the value of the primary password; and
a secondary user selecting the temporary password independently of the value of the primary password.

6. The method of claim 1, further comprising:
granting an unlimited number of accesses to the user account using the temporary password until automatically revoking the temporary password in response to receiving the primary password.

7. The method of claim 1, further comprising:
maintaining a password log for the user account; and
tracking which users access the user account according to which passwords are entered.

8. A computer program product including computer usable program code embodied on a computer usable storage medium, the computer program product comprising:
computer usable program code for securing a user account having a single username using a primary password;
computer usable program code for generating a temporary password for the user account having a different value than the primary password;
computer usable program code for granting access to the user account in response to entry of either the primary password or the temporary password; and
computer usable program code for automatically revoking the temporary password in response to receiving the primary password.

9. The computer program product of claim 1, further comprising:
computer usable program code for granting access to the user account only in response to receiving either the primary password in combination with the single username or the temporary password in combination with the single username.

10. The computer program product of claim 8, wherein the computer usable program code for automatically revoking the temporary password comprises computer usable program code for changing a temporary password field from the temporary password to another value.

11. The computer program product of claim 8, wherein the computer usable program code for automatically revoking the temporary password comprises computer usable program code for changing a temporary password field from the value of the temporary password to a default value equal to the primary password.

12. The computer program product of claim 8, further comprising:
computer usable program code for allowing a primary user to select the value of the primary password; and
computer usable program code for allowing a secondary user to select the temporary password independently of the primary password.

13. The computer program product of claim 8, further comprising:
computer usable program code for electronically generating the temporary password independently of the primary password.

14. The computer program product of claim 8, further comprising:
computer usable program code for granting an unlimited number of accesses to the user account using the temporary password until automatically revoking the temporary password in response to receiving the primary password.

15. The computer program product of claim 8, further comprising:
computer usable program code for maintaining a password log for the user account; and
computer usable program code for tracking which users access the user account according to which passwords are entered.

16. A system, comprising:
an electronic user account having a single username and a primary password for the electronic user account;
an electronic password generator for selectively generating a temporary password for the electronic user account, in addition to the primary password; and
a user interface for receiving login credentials by a human user, for identifying whether the login credentials include the primary password or temporary password, for automatically granting access to the user account in response to entry of the primary password or temporary password, and for automatically revoking the temporary password in response to entry of the primary password.

17. The system of claim 16, further comprising:
a temporary password field included with the user interface, the temporary password having a default value equal to the primary password, wherein the temporary password field is changed to the value of the selectively generated temporary password, and wherein the temporary password is automatically revoked by changing the temporary password field back to the default value equal to the primary password.
